(19) United States
(12) Patent Application Publication
(10) Pub. No.: US 2006/0079327 A1
(43) Pub. Date: Apr. 13, 2006

(54) Electronic device

(76) Inventors: Wolfgang Clemens, Puschendorf (DE); Walter Fix, Nurnberg (DE); Axel Gerlt, Furth (DE)

Correspondence Address: CARELLA, BYRNE, BAIN, GILFILLAN, CECCHI,;STEWART & OLSTEIN, 5 BECKER FARM ROAD, ROSELAND, NJ, 07068, US

(21) Appl. No.: 10/523,487

(22) PCT Filed: Aug. 7, 2003
(86) PCT No.: PCT/DE03/02659

§ 371 Date: Aug. 26, 2005

(30) Foreign Application Priority Data
Aug. 8, 2002 (DE) 10236418.4

(51) Int. Cl. A63F 13/00

(52) U.S. Cl. 463/36

(57) ABSTRACT

So that, in an electronic device, in particular a games device, the execution of a plurality of different functions, in particular game functions, can be performed in a very simple and inexpensive manner, the device comprises a main module (1) and at least one sub-module (2) connectable thereto, wherein the sub-module (2) includes a circuit (13) which in co-operation with a further circuit (5) in the main module (1) enables the device for executing a function specific for the respective sub-module (2) and wherein the circuit (13) in the at least one sub-module (2) is in the form of an organic circuit. In that case the sub-module (2) can be selected from a plurality of different types of sub-modules each having respectively different circuits for different functions.

The invention concerns an electronic device.

Electronic devices, for example games devices, permit the execution of functions (games) in dependence on a function logic (game logic) contained therein, wherein the function (game) can be influenced by way of input means, in the simplest case can be switched on and off, and items of information occurring in connection with execution of the function (items of game information such as for example game statuses, sequence of players or defeats suffered by players) can be optically and/or acoustically displayed by way of display means. The function logic can be implemented in the form of hardware and/or software in the device.

As is known from Fraunhofer Magazin 4, 2001, pages 8 through 13, conducting or semiconducting plastic materials have for some time now opened a way to inexpensive mass production of electronic components and circuits. Examples in this respect are foil batteries, organic solar cells, displays comprising organic light emitting diodes (OLEDs) and integrated circuits of (semi-)conducting organic materials such as for example polymers (integrated plastic circuits=IPCs). Terms such as organic electronics, polymer electronics, polytronics, electronic plastics or conductive polymers are often used synonymously for that new technology. In that case, the complete component or the complete circuit does not have to consist of organic materials, but it is sufficient for the parts which are crucial for the function involved to comprise the conducting or semiconducting organic material.

The object of the present invention is to provide an electronic device which in a simple and inexpensive manner permits the implementation of a large number of different functions.

In accordance with the invention that object is attained by an electronic device comprising a main module and at least one sub-module connectable thereto, wherein the sub-module includes a circuit which in co-operation with a further circuit in the main module enables the device for executing a function specific for the respective sub-module and wherein the circuit in the at least one sub-module is in the form of an organic circuit.

The device according to the invention is preferably a games device, the function being a gaming function.

The essential advantage of the electronic device according to the invention is that, depending on the respective sub-module connected to the main module, it is possible to implement different functions of the device, wherein the sub-module can be produced at very low cost as a mass-produced article by virtue of the fact that its circuit is in the form of an organic circuit. In that case the sub-module can be selected from a large number of different types of sub-modules each having respectively different circuits for different functions. In this connection the sub-module itself is preferably in the form of a plastic card or foil on which the circuit is embodied for example using a printing process, for example employing polymers in solution (so-called electronic ink). Therefore the plastic card and in particular the plastic foil, as a mass-produced article which is very cheap to produce, can be added at no cost to different sales products such as for example journals and magazines, foodstuff packagings, surprise eggs and so forth, with more and more new functions. Here the term functions, such as for example games functions, is used to denote both complete independent functions, for example complete games, and also parts of functions, for example parts of a game, or function variants, such as for example variants of a function. Thus for example a plurality of different sub-modules can be fitted to a toy spaceship as the main module, which sub-modules perform different games functions such as for example a protective shield function, attack weapons, spaceship drive, on-board power supply. Connecting the sub-module to the main module generally involves fixing the sub-module to the main module, for example also glueing it on, in which case the two circuits communicate with each other either in contact-linked fashion, for example by way of a plug connector, or contactlessly, for example by way of a transponder function, for example radio frequency identification—RFID, or optically, for example with a light- emitting element and a light detector.

In order to make the sub-modules attractive for collecting or exchanging, it can advantageously be provided that at least two sub-modules can be connected to the main module, which sub-modules can be selected from a large number of different types of sub-modules each having respectively different circuits, wherein it is only with predetermined combinations of types of sub-modules, that the circuits thereof, in a condition of co-operating with the further circuit in the main module, enable the device for performing a function which is specific for the respective combinations of types of sub-modules. Thus for example two game players can execute a given function jointly with the games device according to the invention only when the sub-modules which are in the possession of the players permit that in combination.

As a cheap mass-produced article the sub-modules are preferably conceived as a throw-away article, for which purpose one of the two circuits in the sub-module and the main module respectively has switch-off means which detect use of the sub-module on the main module and permanently prevent further co-operation of the two circuits after a predetermined extent of use has been exceeded. In the simplest case the switch-off effect takes place in the sub-module, insofar as the circuit thereof, for example by virtue of an alteration to an item of bit information which is relevant in terms of function, is altered or is destroyed at a location which is relevant in respect of function. The prevention of further co-operation of the two circuits in the main and sub-modules can be effected after single use or multiple use. In that respect the switch-off means for detecting the extent of use of the sub-module are preferably adapted for monitoring the performance of the executed function, for example the performance of the game, wherein, in dependence on the game status, after a predetermined number of game moves or actions on the part of the player or after a predetermined number of played, won or lost games, further use of the sub-module is rendered impossible.

The functions which can be performed by the device can be implemented in the form of function logic in the circuit of the main module, wherein the circuit in the sub-module has enable means for enabling the respective specific function in the main module. In addition or alternatively the circuit in the sub-module may include an additional logic which, together with a function logic contained in the main module, permits execution of the respective function. In that case the additional logic and the function logic can be implemented in hardware and/or software terms in the respective circuits of the main and sub-modules.

For influencing the function executed by the device according to the invention and/or for displaying items of information which occur in connection with function execution, the at least one sub-module preferably has input means, for example a press switch or sensor, and/or display means such as for example an organic light emitting diode, an electrochromic element or an electroluminescent element.

For further description of the invention attention is directed hereinafter to the Figures of the drawing in which:

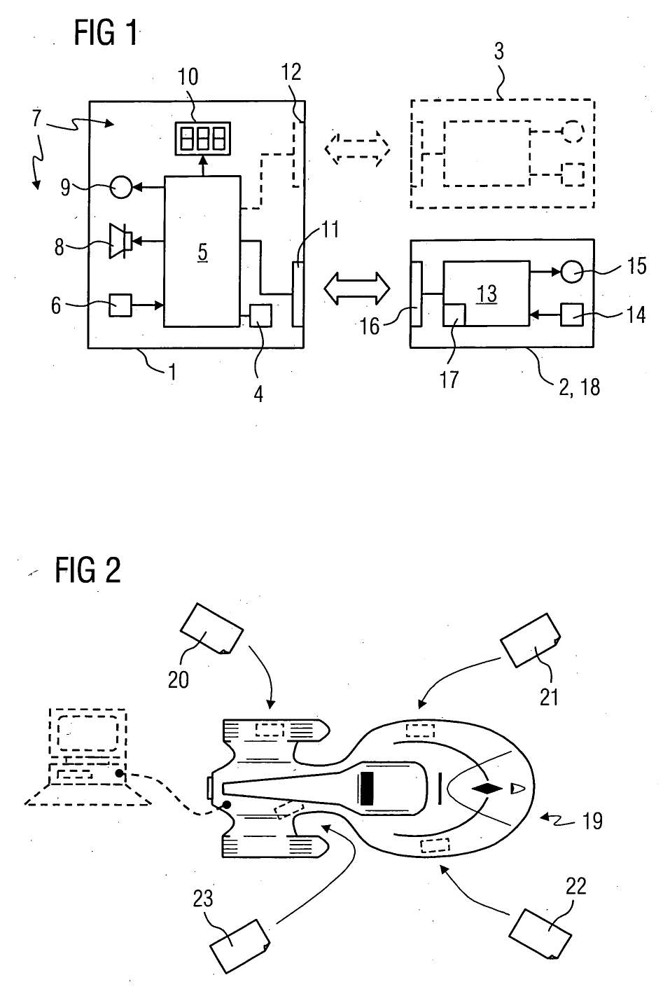

FIG. 1 shows an embodiment by way of example of the device according to the invention in the form of a games device, and

FIG. 2 shows a further embodiment by way of example of the device according to the invention with a plurality of sub-modules.

FIG. 1 is a view in the form of a simplified block circuit diagram showing the electronic games device comprising a main module 1 and at least one sub-module 2. As indicated in broken line the main module 1 can possibly be adapted for use with further sub-modules 3.

The main module 1 includes a circuit 5 which is fed from a power source 4, for example a battery or a solar cell, and with which a function logic, here a games logic, is embodied in hardware and/or software terms. Connected to the circuit 5 are input means 6, for example keys or sensors (for example for temperature or light) for influencing the game, and display means 7, here for example a loudspeaker 8, a lamp 9 and a display 10 for acoustic or optical display of items of game information. The circuit 5 also has a connecting portion 11, for example a plug portion or an inductive pick up, for the electrical connection of the sub-module 2, and possibly further connecting portions 12 for the further sub-modules 3.

The sub-module 2 also includes a circuit 13 with input means 14 connected thereto for influencing the game and display means 15 for displaying items of game information, as well as with a connecting portion 16 for connection to the connecting portion 11 of the main module 1. The structure of the further sub-modules 3 corresponds to that of the sub-module 2. The circuit 13 of the sub-module 2 includes an additional logic which is embodied in hardware and possibly software terms and which, together with the game logic contained in the main module 1, permits execution of a game function which is specific for the respective sub-module. The circuit 13 of the sub-module 2 further includes switch-off means 17 which detect the use of the sub-module 2 on the main module 1 and permanently prevent further co-operation of the two circuits 5 and 13 after a predetermined extent of use has been exceeded. The switch-off means 17 here are in the form of a logic portion which is required for functioning of the circuit 13, for example a given bit combination, which, during the game process, for example after a predetermined number of games have been played, is permanently altered by the circuit of the main module 1, for example destroyed by a flow of current. The sub-module 1 is then no longer to be used.

The circuit 5 in the main module 1 takes over the main work involved in performance of the game function while the circuit in the sub-module 2 only looks after minor tasks which however are indispensable for playing the game. Accordingly the circuit 5 of the main module 1 is comparatively complex and is typically produced using conventional silicon technology. The comparatively simple circuit 13 and the input and display means 14 and 15 of the sub-module 12 are in contrast embodied using polymer electronics, here in the form of IPC and OLED, in which case the sub-module 2 itself is in the form of a plastic card or foil.

FIG. 2 shows a main module 19 which is in the form of a toy spaceship and to which four different types of sub-modules 20, 21, 22 and 23 each with respectively different circuits can be connected at different locations. Each of the sub-modules 20, 21, 22 and 23, in a condition of co-operating with the circuit in the main module 19, performs a partial function, such as for example a protective shield function, attack weapons, spaceship drive and on-board power supply, in the context of an overall game function. The partial functions can be independent of each other so that the game can also be performed only with one sub-module, for example 21, but then in a restricted scope, or the partial functions can be dependent on each other so that a game is possible only when one is in possession of at least two, three or all four mutually suited types of sub-modules. A different combination of mutually suited sub-modules permits another game variant with the same main module 19. Other types of sub-modules may be unusable for the toy spaceship 19 shown here, but suitable for other types of game devices.

Instead of the games devices illustrated here by way of example, it is also possible to envisage other electronic devices, for example communication devices or medical devices, in which case the sub-modules enable the respective main module to perform different communication functions or patient-related diagnostic functions.

1. An electronic device comprising;
a main module; and
at least one sub-module electrically connectable to the main module, wherein the sub-module includes an electric circuit which in co-operation with a further electric circuit in the main module enables execution of a function specific for the respective sub-module and wherein the circuit in the at least one sub-module is organic.

2. An electronic device as set forth in claim 1 wherein the main module circuit and sub-module circuit are arranged to form a the function of a game.

3. An electronic device as set forth in claim 1 wherein at least one further sub-module is electrically connected to the main module, which sub-modules are selected from a plurality of different types of sub-modules each having respectively different circuits, wherein it is only with predetermined combinations of types of sub-modules, that the circuits thereof in cooperation with the further circuit in the main module, enable performance of a function specific to the respective combinations of types of sub-modules.

4. An electronic device as set forth in claim 1 wherein the sub-module is in the form of one of a plastic card and a plastic foil.

5. An electronic device as set forth in claim 1 wherein one of two circuits in the sub-module and the main module respectively has a switch-off arrangement which detects the use of the sub-module on the main module and permanently prevents further co-operation of the two circuits after a predetermined extent of use is exceeded.

6. An electronic device as set forth in claim 5 wherein the switch-off arrangement is adapted to monitor the progress of the function being performed, to detect the extent of use of the sub-module.

7. An electronic device as set forth in claim 5 wherein a circuit in the sub-module has enable means for enabling the respective specific function in the main module.

8. An electronic device as set forth in claim 5 wherein a circuit in the sub-module includes an additional logic which together with a function logic contained in the main module permits the execution of the respective function.

9. An electronic device as set forth in claim 5 wherein the sub-module has input means and/or display means for influencing the function or display of items of information occurring in connection with execution of the function.

10. An electronic device as set forth in claim 6 wherein a circuit in the sub-module has enable means for enabling the respective specific function in the main module.

11. An electronic device as set forth in claim 6 wherein a circuit in the sub-module includes an additional logic which together with a function logic contained in the main module permits the execution of the respective function.

12. An electronic device as set forth in claim 7 wherein a circuit in the sub-module includes an additional logic which together with a function logic contained in the main module permits the execution of the respective function.

13. An electronic device as set forth in claim 6 wherein the sub-module has input means and/or display means for influencing the function or display of items of information occurring in connection with execution of the function.

14. An electronic device as set forth in claim 7 wherein the sub-module has input means and/or display means for influencing the function or display of items of information occurring in connection with execution of the function.

15. An electronic device as set forth in claim 8 wherein the sub-module has input means and/or display means for influencing the function or display of items of information occurring in connection with execution of the function.
